(19) United States
(12) Patent Application Publication
(10) Pub. No.: US 2025/0307965 A1
(43) Pub. Date: Oct. 2, 2025

(54) AI-POWERED PET TRAVEL ASSISTANT APP

(71) Applicants: Bradley Carl Pauer, Irvine, CA (US); Angela Thuy-An Le, Irvine, CA (US); Sauradeep Paul, Mountain View, CA (US)

(72) Inventors: Bradley Carl Pauer, Irvine, CA (US); Angela Thuy-An Le, Irvine, CA (US); Sauradeep Paul, Mountain View, CA (US)

(21) Appl. No.: 19/098,814

(22) Filed: Apr. 2, 2025

Related U.S. Application Data
(60) Provisional application No. 63/573,327, filed on Apr. 2, 2024.

(51) Int. Cl. G06Q 50/14

(52) U.S. Cl. CPC G06Q 50/14

(57) ABSTRACT

An artificial intelligence powered pet travel app is provided. The app includes a processor and program instructions executed by the processor that allow the app to converse with a user via a chatbot to determine pet-travel data for a user planning a trip with a pet. The app generates and displays a travel document for the user based on the pet-travel data.

### CROSS-REFERENCE TO RELATED APPLICATION

This application claims priority to U.S. Provisional Application No. 63/573,327, filed Apr. 2, 2024, and entitled “AI-POWERED PET TRAVEL ASSISTANT APP,” the disclosure of which application is hereby incorporated by reference in its entirety.

### BACKGROUND

Traveling with pets can be a complex and stressful process. Understanding pet travel regulations, booking pet-friendly accommodations, and ensuring a smooth travel experience for both owner and pet requires significant research and effort. Existing travel apps and booking agents often lack dedicated pet travel expertise, leading to frustration and wasted time. What is needed is a better way to assist a pet owner to travel with a pet.

### SUMMARY

Disclosed herein are embodiments of an artificial intelligence (AI) powered pet travel app. In some aspects, the app can include a processor and one or more computer-readable data storage devices storing program instructions that when executed by the processor control the AI powered pet travel assistant app to perform operations comprising: determining, by conversing with a user via a chatbot, a pet-travel data selected from the group consisting of: a travel destination, a travel mode, a pet characteristic, a user characteristic, a pet accommodation, a legal requirement, and a medical characteristic; generating a travel document based on the pet-travel data, and displaying the travel document to the user. The app can further be configured to access one or more information sources through a data channel. The app can use a set of agentic workflows to scan a plurality of information sources to obtain relevant travel information for the user.

Also disclosed herein are embodiments of a method of generating a pet-travel document using an artificial intelligence powered pet travel assistant app. In some aspects, the method can include the app using a chatbot to converse with a user by exchanging queries and replies with the user to identify one or more pet-travel characteristics of a trip the user is planning with a pet. The method can further include the app accessing an information source to obtain relevant trip data for the user based on the pet-travel characteristic the chatbot has learned by conversing with the user. The method can further include the app generating a travel document based on the trip-relevant data the app obtained from the information sources.

### BRIEF DESCRIPTION OF THE DRAWINGS

Embodiments of the present disclosure will now be described hereinafter, by way of example only, with reference to the accompanying drawings in which:

FIG. 1 depicts a schematic representation of an AI-powered pet travel assistant app, according to some aspects of the present disclosure.

FIG. 2 depicts an AI-powered pet travel assistant app, according to some aspects of the present disclosure.

FIG. 3 depicts a schematic representation of a method of accessing an AI-powered pet travel assistant app, according to some aspects of the present disclosure.

FIG. 4 depicts a schematic representation of a method of interacting with an AI-powered pet travel assistant app, according to some aspects of the present disclosure.

FIG. 5 depicts a schematic representation of an AI system of an AI-powered pet travel assistant app, according to some aspects of the present disclosure.

### DETAILED DESCRIPTION

### Overview

This disclosure relates generally to an artificial intelligence (AI) powered pet travel assistant app. In some aspects, the AI-powered pet travel assistant app of the present disclosure can simplify pet travel for pet owners worldwide. As described herein, the app can include an AI-driven travel-planning and booking interface. In some arrangements, an AI-powered chatbot can interact with the user in natural language to gather from the user contextual and personalized travel data such as, for example, a transportation method (e.g., air, car, train, ferry, cruise), a departure location, a destination location, a date or duration of travel, and pet-specific information (e.g., species, breed, size, age, medical conditions, behavioral traits, travel history). The app can act as a one-stop shop for booking pet-friendly flights, rental cars, hotels, trains, restaurants, and other travel needs. The chatbot can enable the user seamless access to travel accommodations and services within the platform. Unlike general travel apps, the app of the present disclosure can cater exclusively to the needs of pet owners, offering specialized travel regulations, booking options, and resources. Based on data the app gathers from the user (e.g., via the chatbot) and through other means described herein, the app can generate a customized pet travel itinerary or other relevant travel document for the user. The app can verify the customized itinerary complies with relevant transport and jurisdictional rules. The app disclosed herein can empower pet owners to travel the world with their furry companions with ease and confidence. The comprehensive, AI-powered app disclosed herein represents a significant leap forward in pet travel convenience and simplifies the entire journey from planning to execution.

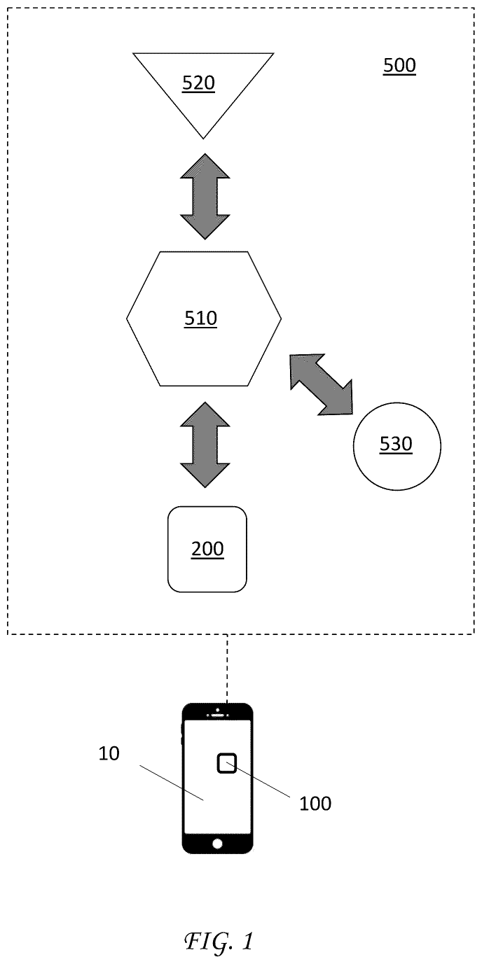

FIG. 1 shows an illustrative, non-limiting example of an artificial intelligence (AI) pet travel assistant app 100, according to some aspects of the present disclosure. The app 100 is shown in FIG. 1 as being accessed through a mobile device 10. In some arrangements, the app 100 can be accessed through a computing device such as a desktop computer, laptop computer, tablet computer (e.g., iPad), or other mobile device. In some arrangements, the app 100 can be stored locally on the computer (e.g., mobile device) through which the app 100 is accessed. In some arrangements, the app 100 can be stored on a remote server and accessed through a computer (e.g., mobile device 10). As described more fully herein, the app 100 can be configured to facilitate pet travel by assisting a user to access, process, coordinate, and synthesize information from a variety of information sources 200 (FIG. 1) that are relevant to pet travel.

FIG. 1 illustrates the app 100 can comprise an AI system 500 that powers the functionality of the app 100 to assist a user in planning, booking, and monitoring a pet-inclusive trip. For the sake of simplicity, the AI system 500 in FIG. 1 is depicted in a block-diagram format. However, the skilled artisan will appreciate that the AI system 500 can include one or more computing devices that interact with the user. The AI system 500 can include hardware (e.g., a computing device, an input/output device, a computer-readable storage device) and software that perform the processes and functions disclosed herein. As shown in FIG. 1, the AI system 500 can include an AI processor module 510. The AI processor module 510 can comprise one or more processors (e.g., microprocessor, microchip, or application-specific integrated circuit), one or more memory devices (e.g., RAM or ROM), one or more user interfaces, one or more network interfaces. As described herein, the AI processor module 510 can execute one or more computer program instructions (e.g., an operating system, an application program), which can be stored in the memory device or storage system. The AI processor module 510 can access one or more information sources 200 (e.g., a database, a library, a general distribution service), as described herein.

With continued reference to FIG. 1, the AI system 500 can include a chatbot 520 through which the AI system 500 gathers from the user relevant travel information (e.g., travel destination, pet characteristics). The chatbot 520 can converse with the user by presenting a query to the user to elicit a response from the user. The AI system 500 can include one or more computer programs that can use logical rules or heuristic rules to determine and select interview questions for the chatbot 520 to present to the user to elicit desired information. The computer programs of the AI system 500 can be stored on one or more computer-readable storage devices and can be accessed, and executed, by the processor module 510. The AI system 500 can guide or modify the chatbot 520 interaction with the user based on information that the AI system 500 acquires from the information source 200. For example, the AI system 500 can access an information source 200 such as an airline ticket inventory database and refine interaction of the chatbot 520 with the user based on the inventory information the processor module 510 has learned from accessing the information source 200. The AI system 500 can further include a synthesis module 530 that can direct or guide the system 500 based on the information the AI system 500 acquires through the chatbot 520 and through the information sources 200. For example, the synthesis module 530 can determine from the user interaction with the chatbot 520 and an information source 200 that a vaccination record is required to bring the user's pet to the desired travel destination. The synthesis module 530 can determine what additional information is needed to complete the vaccination document and can direct the chatbot 520 to elicit from the user such additional information (e.g., date of last rabies vaccination for the pet). As another example, the synthesis module 530 can assimilate information from the chatbot 520 and the information sources 200 to create a travel itinerary or checklist for the user.

In some arrangements, the app 100 can offer a comprehensive suite of features to ensure a seamless travel experience. In some aspects, the app 100 can eliminate the need to consult multiple sources by offering a comprehensive suite of travel planning and booking tools within a single app. The app 100 can streamline the booking process by integrating directly with travel providers, eliminating the need for traditional booking agencies, and reducing customer wait times. In some arrangements, the app 100 can also offer convenient access to pet travel essentials so that users can plan and buy everything they need for their upcoming travels. In certain aspects, the app 100 can provide informative content within the app 100, enhancing user experience and convenience. In some arrangements, the app 100 can utilize a user-friendly chat interface (e.g. a chatbot 520), as described herein.

In some aspects, the app 100 can reduce or eliminate the risk of accidentally booking portions of a trip that may conflict for the traveling pet (e.g., a booking that has a “dog-appropriate” transport ticket coupled with a “cat-appropriate” destination accommodation). In some arrangements, the app 100 can reduce or eliminate the risk of failing to perform each required step of a smooth pet travel experience. For example, the app 100 can be configured to alert the user that a booking with a “cat-appropriate” destination accommodation has not been associated with a “cat-appropriate” documentation (e.g., proof of vaccination) that may be required by the destination government. The app 100 can provide immediate updates to a user whose pet-travel plans may be affected by a change in one or more regulations at the travel destination (e.g., a change in quarantine procedures). In this way, the app 100 can reduce the stress of pet travel for a user of the app 100 because the user can rest assured he or she will be informed of, and able to respond to, any last minute pet-travel-relevant changes that may occur after the user has booked a trip through the app 100 but before the user has embarked on that trip. In some arrangements, the app 100 can be configured to update the user via email, or SMS text messages, or through “in-app” notifications to ensure for the user a seamless journey even if changes occur.

### Certain App Functionalities

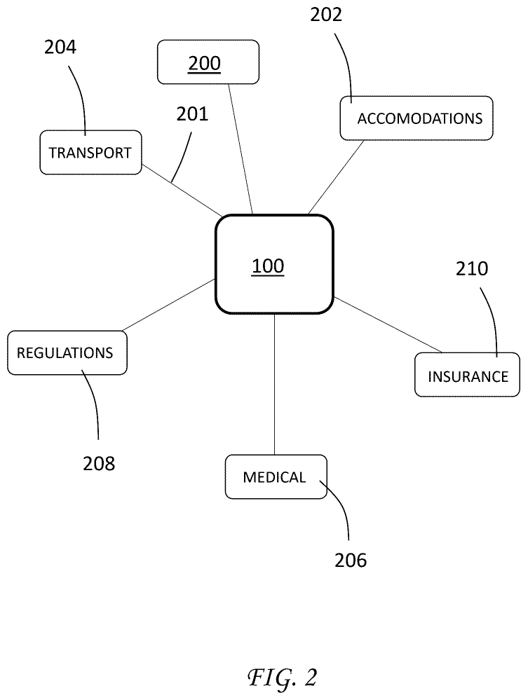

FIG. 2 depicts schematically an illustrative, non-limiting example of an AI-powered pet travel assistant app 100, according to some aspects of the present disclosure. The app 100 can facilitate access to, and processing of, relevant pet-travel information from one or more information sources 200. As described herein, the app 100 can synthesize the information from the one or more information sources 200, for example, by populating a form to present to the user so that the user can then make decisions to continue the customer journey of booking the trip or just to learn more.

The information source 200 can be a database, a network, a server, a verified data source, a proprietary data source, an online database, and offline database, or other sources of electronically-stored information. In some arrangements, the information source 200 can be a publicly-accessible information source (e.g., an airline's website). The app 100 can be configured to use a web crawler or to scan only verified websites such as official airport pages and government websites, for example. In some arrangements, the information source 200 can be one that restricts access (e.g., licensed data). In some arrangements, the information source 200 can be one that only allows access through the app 100 (e.g., app-generated data). In some aspects, the information source 200 can be an information source 200 that is generated through user interaction with the app 100. For example, the information source 200 can include a search history or booking history of a particular user, or a particular sub-group of users of the app 100, or of the entirety of the group of users that have interacted with the app 100. In some arrangements, the app 100 can improve result accuracy and reliability by the app 100 aggregating both online and offline information sources 200 such as, for example: digitally-accessible regulatory databases; verified information from government agencies, consulates, or embassies; direct phone-base confirmations with airlines, hotels, and pet-service providers; in-person research and verified field data submitted by internal teams and trusted users. This hybrid aggregating approach can allow the app to deliver real-time verified guidance, reducing reliance on outdated and generalized web content.

In some aspects, the information source 200 can be directed to one or more particular feature or consideration for pet-travel. For example, the app 100 depicted in FIG. 2 is configured to interact with an accommodations information source 202, with a transport information source 204, with a medical information source 206, with a regulations information source 208, and with an insurance information source 210. In some arrangements, the app 100 can include content that is generated by a “fact checker” who may call different hotels, trains, airports, etc., to confirm data if that data is not to be found during the scan performed by the app 100. The content generated by the “fact checker” (e.g., periodic updates to content not displayed online) can be hosted in the app 100 to enhance the user experience of the app 100. In some arrangements, partnerships can be formed with various brands to enable even faster updates or to possibly even influence policies.

With continued reference to FIG. 2, the app 100 can access the information source 200 through a data channel 201 (e.g., internet connection). The data channel 201 can allow the app 100 to access or receive information on the one or more information sources 200, 202, 204, 206, 208, 210. In some arrangements, the data channel 201 can allow the information source 200, 202, 204, 206, 208, 210 to receive or access information from the app 100. For example, the app 100 shown in FIG. 2 depicts the app 100 connected to a transport information source 204 by a data channel 201. In some arrangements, the data channel 201 can allow the app 100 to search a transport information source 204 for relevant pet-travel ticket information. For example, the transport information source 204 can be a travel-related website (e.g., airline website) from which the app can glean information about pet-friendly travel options for different: departure times, arrival times, connecting flights, price points, bidding options, packaged deals.

As shown in FIG. 2, the app 100 can acquire relevant pet-travel information by searching information sources 200 directed to different aspects of pet travel, such as, pet-friendly accommodations, pet-friendly restaurant reservations, insurance, regulations, and medical considerations. In some arrangements, the app 100 can maintain an information source 200 comprising a curated, vetted, and approved database of pet-friendly establishments including, for example: hotel and vacation rentals; restaurants and cafes; parks, beaches, hiking trails, campsites, and green spaces; pet-welcoming stores and shopping areas; pet services (e.g., grooming, daycare, emergency clinics). The app 100 can use this curated database information source 200 to recommend establishments aligned with the user's destination, preferences, and pet profile, ensuring an enjoyable, pet-inclusive experience. In some aspects, the information sources 200 may overlap. For example, a regulation information source 208 may contain information about quarantine and vaccination regulations, which may also be found by the app 100 in a medical information source 206. In some aspects, the app 100 can identify conflicting or concurring information. In some configurations, the app 100 can alert the user to conflicting or concurring information. The app 100 can be configured to allow pet owners to make reservations through the app 100, for example, to stop at places to eat that are pet-friendly along their travels.

The AI system 500 of the app 100 can synthesize the information from the various information sources 200 and display to the user a selection of pet-friendly travel options (e.g., packaged deals, travel date options). The AI feature of the app 100 can identify aspects of a pet-and-owner trip that interfere with one another. The AI feature can determine and display to the user one or more solutions to resolve the detected conflicts. In some aspects, the chatbot 520 of the app 100 can be configured to integrate information from the manual inputs from “fact-checker” who may have contacted various businesses or government agencies to ensure the app 100 has been provided all relevant and up-to-date information to process and present to the user. In this way, the app 100 can ease the frustration of travel planning because the app 100 will more quickly and more accurately evaluate the large quantities of information that are needed to be considered for the various aspects of pet-travel. The app 100 can quickly find multiple solutions that meet the travel criteria of the user, which saves time compared to an individual having to iteratively develop a pet-friendly travel plan. In some aspects, the app 100 can provide a platform for partnerships with businesses and government entities that allow users of the app 100 to learn faster about regulations and policies as well as influence them.

The AI system 500 of the app 100 can provide real-time monitoring and alerts. The app 100, via the AI system 500 disclosed herein, can include a regulatory intelligence engine that proactively monitors changes in policies or regulations that could impact the user's anticipated pet-travel experience. For example, the app 100 can monitor and inform the user regarding relevant travel information such as, for example: local, state, national, and international pet-travel policies; airline and transportation carrier rule; health certificates or vaccination requirements; import or export conditions, breed-specific restrictions, quarantine rules; weather conditions that may affect travel or pet safety. In some arrangements, the app 100 can notify the user of any changes that may impact the user's journey through automated, real-time alerts, minimizing last-minute disruptions or denials at check-in. In some variants, the app 100 can provide the user with options for overcoming any such disruptions or changes in travel regulations.

The AI system 500 of the app 100 can provide an adaptive pet-travel generator (e.g., a synthesis module 530) that can generate for the user a dynamic checklist personalized to the user. The app 100 can use the chatbot 520 to elicit relevant information, as described herein, and provide the user a dynamic checklist that includes such information as, for example: required documents; packing suggestions (e.g., medications, carriers, food, accessories); pet comfort and safety items tailored to weather and destination conditions; task reminders (e.g., vet visits, forms, travel insurance). In some arrangements, the dynamic checklist can evolve as the travel plan updates, helping a user stay prepared across both short-term and long-haul travel, including international relocation.

The AI system 500 of the app 100 can provide a persistent profile learning and recommendation engine. In some arrangements, the app 100 can feature persistent data storage and machine learning capabilities that allow the app 100 to remember and adapt to user data such as, for example: booking history, search history, past travel logistics and preferences, pet-specific needs, user feedback. The AI system 500 can enable the app 100 to provide a user hyper-personalized recommendations for future travel, enhancing user satisfaction and convenience over time. The app 100 can include a fully-integrated booking and fulfillment system. The app 100 can include a comprehensive booking infrastructure powered by third-party integrations (e.g., global distribution systems, hotel and airline APIs). As described herein, the app 100 can allow a user to search and book verified pet-friendly accommodations (e.g., hotels, vacation rentals). The app 100 can allow a user to reserve transportation services including: commercial airlines with airline-specific pet policies, car rentals, train services, ferry services, private and semi-private air carriers. The app 100 can assist a user to discover and optionally book activities and pet services such as grooming or daycare and can provide a user access tools for travel documentation and compliance management. In some arrangements, the app 100 can provide a user a free service (e.g., to independently book a service directly through the app 100) while also providing other services on a subscription or fee basis (e.g., utilizing the AI chatbot 520 for automated full-service booking and itinerary execution including end-to-end trip management, concierge-style booking support, and bundled recommendations). The app 100 described herein can be used for each domestic and international travel, creating a scalable and compliant experience across various travel types and geographic regions.

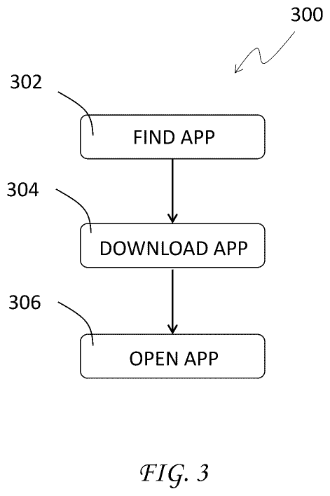

FIG. 3 illustrates a non-limiting, illustrative example of an access method 300 through which a person (e.g., a pet owner who wants to travel with a pet) can acquire access to the app 100. A find step 302 in the access method 300 can include finding the app 100 from an online source (e.g., Apple App Store, Google Play Store, #Kruiz). A download step 304 in the access method 300 can include downloading the app 100 to a computer (e.g., mobile device, desktop, laptop, tablet). An open step 306 in the access method 300 can include opening the app 100 on the computer to which the app 100 was downloaded. In some arrangements, the app 100 may be configured such that the first time a user opens the app 100 the user is greeted with a welcome screen and an optimized onboarding experience for first time users. The app 100 can prompt the user to sign up or to login. The app 100 can prompt the user to input data about the user, such as, for example, the user's: full name, address, email, phone number, birthdate, passport number, driver's license (or other ID) number, known TSA or Global Entry numbers. In some arrangements, the app 100 can collaborate with a third-party service provider (e.g., Clear, Plaid, Veriff) to implement a Know Your Customer (KYC) service whereby the third-party service provider can assist the app 100 to identify users quickly (e.g., within seconds) and simply (e.g., with shortened data input experience for user). In some arrangements, the third-party service provider can assist the app 100 to perform tasks such as, for example, authenticating IDs, confirming liveness, and screening global watchlists.

As discussed herein, the app 100 can leverage AI (e.g., machine learning, a retrieval-augmented generation system) to provide real-time guidance on pet travel requirements for different countries and cities, including necessary vaccinations, documentation, and quarantine regulations. In some aspects, the app 100 can include a chat interface that can act as a virtual travel assistant, offering personalized advice and recommendations for pet preparation, pet-friendly activities at destinations, and locating certified vets for travel-related health checks and vaccinations. In some aspects, the chat interface can simplify user interaction and can eliminate the need for complex navigation menus.

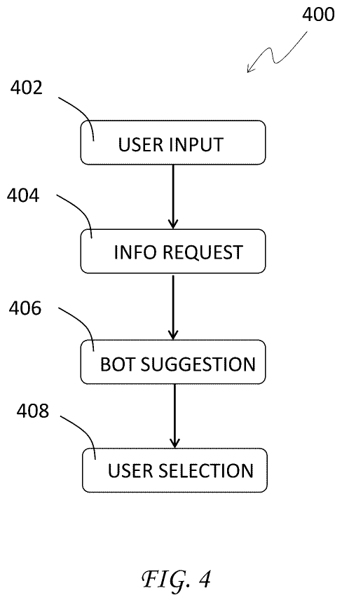

FIG. 4 shows a non-limiting, illustrative example of an interaction method 400 by which a user can interact with an AI feature of the app 100. The interaction method 400 can begin with a user input step 402, which can include a user engaging in a conversation interaction with an AI bot of the app 100. For example, the user input step 402 can include the user typing in a question, such as, “where can I visit in Fiji with my dog?” In some aspects, the user input step 402 can include the user inputting to AI bot of the app 100 one or more details about a desired trip with the user's pet, such as, for example, “travelling to Spain with a diabetic turtle.” The AI bot of the app 100 can be configured to scan for various information from the web and other information sources 200 and share how best to travel with a pet having unique requirements. The app 100 can also scan, process, and display information such as, for example, vet services near the user's destination as well as over insurance options. The app 100 can include other add-ons that are specifically tailored for the user. The app 100 can provide access to an in-house vet or vet partner that could help answer medical-related questions a user may have. The app 100 can allow the data points related to the medical-related information of a pet of the user to be entered into a database of the app 100. In some arrangements, the user input step 402 can include the AI bot of the app 100 displaying a prompt that asks the user to input or indicate a question or detail for a desired trip.

In some configurations, the AI system 500 of the app 100 can use the inputs from the user to help construct travel packages pertaining to the unique needs of the user as identified by the app 100 through the user inputs. This can reduce the number of back-and-forth interactions the user would normally encounter when booking for themselves and their pet (e.g., selecting a flight, selecting a seat, paying pet fees, checking bags, selecting in-flight meals, booking hotels, restaurants, transportation, etc.). For example, the user can interact with the AI chatbot 520 of the app 100 by inputting conversational language such as, for example, “I want an aisle seat, business class, to travel with my dog in the cabin, and I want a meal in the cabin as well as 2 bags. I am leaving on xx date and returning xx date. I prefer XX airlines but am comfortable with other options.” The chatbot 520 can be configured to scan and synthesize data, as disclosed herein, and return to the user output such as displaying options (e.g., A, B, C) for the user to consider. The user can further refine packages from there or ask for new options.

As shown in FIG. 4, the interaction method 400 can include an information request step 404. The information request step 404 can include the chatbot 520 asking the user to provide some details about the user, such as, for example: the type of pet with which the user is traveling, the age of the pet, the pet's weight, the name and address of the owner, other pet-special requirements or relevant pet-special information that is important to know (e.g., medications, allergies). In some aspects, the information request step 404 can include the chatbot 520 asking the user to input travel details, such as, for example: the travel destination or destinations, the duration of the travel, preferences for pet accommodation and care, whether accommodations can be a combination of different types of accommodations (e.g., hotel, Airbnb) or must be only of one type, the desired or acceptable or unacceptable modes of transport (e.g., plane, train, rental car, taxi, car service, ferry), whether pet and owner travel together (e.g., pet in cabin) or apart (e.g., pet in the hold) or at separate times (e.g., pet traveling alone for one or more portions of a journey).

With continued reference to FIG. 4, the interaction method 400 can include an AI-bot suggestion step 406, in which the AI system 500 via the chatbot 520 provides the user a suggestion based on the information the app 100 has obtained about the user, or based on a scan of one or more information sources 200 by the app 100, or based on a combination of these aforementioned bases. For example, the AI-bot suggestion step 406 can include the app 100: generating travel plans based on the user's data and user's input, presenting various options for pet accommodation, suggesting pet-friendly activities at the destination, suggesting an itinerary planner feature of the app, providing options for pet transport (e.g., comprehensive packages that meet all the needs of the pet owner, a plurality of options with different pricing tiers).

In some aspects, the app 100 can act as a one-stop shop for booking pet-friendly flights, rental cars, hotels, trains, dining, and other travel needs. The app 100 can integrate with leading travel providers for a smooth booking experience. In some arrangements, the app 100 can allow users to create and manage detailed itineraries, including flight times, hotel stays, vet appointments, and pet-friendly activities. This can ensure that all travel details are accessible and organized in one location. In some configurations, the app 100 can automatically generate a travel itinerary for the user. The app 100 can display an itinerary, whether user-generated or automatically-generated, for a booked trip or for a trip that is still being considered or one that is being modified. In some configurations, the itinerary can be user-generated, automatically-generated, or a combination thereof, for example, with the app 100 allowing a user to modify or edit an itinerary after booking. In some arrangements, once the itinerary is booked, the app 100 can provide the user the option to sync the information to the user's preferred calendar (e.g., gmail, apple calendar, outlook, yahoo, etc.).

The app 100 can include a built-in library of informative content, including blog articles, travel guides, and tips on how to best travel with pets. Additionally and alternatively, the app 100 can feature a curated shop for purchasing essential pet travel gear and accessories. In some aspects, the app 100 can offer pre-configured travel packages designed to reduce stress and simplify the booking process. These packages can combine various travel components catering to specific destinations and pet needs.

In some arrangements, the app 100 can operate on a commission-based model. For example, the app 100 can be configured to charge a percentage (e.g., 1.5-4%, 10-20%) transaction fee on bookings and purchases made within the app 100. In some arrangements, the app 100 can have a deluxe or exclusive membership group of users who pay a membership fee in order to be granted access to special promotions or offers through the app 100. In some arrangements, the app 100 can provide the option to purchase pre-configured pet travel packages and pet travel essentials.

In some arrangements, the app 100 can go beyond booking to create a fun and engaging user experience through gamification. For example, the app 100 can offer a point system of rewards. Every action with the app 100 can earn a user reward points. In some configurations, the app 100 can reward points to the user for completing tasks (e.g., booking a trip through the app 100), or for using the AI assistant of the app 100, or for reading some content (e.g., a travel guide) of the app 100, or for leaving a review through the app 100. The app 100 can also include a leaderboard ranking system. For example, users of the app 100 can compete on individual and community leaderboards to see who has traveled the most miles with their pet, or traveled to the most countries, or booked the most trips, or accumulated the most reward points. In some arrangements, the app 100 can include a social or community tab where users can see the user's ranking in the leaderboard and also interact with other users. In some variations, the app 100 can be configured to unlock perks for the user. For example, the app 100 can be configured to unlock exciting rewards upon the user reaching a specific reward-point milestone (e.g., a number of user-earned reward points). The exciting perks can include, for example, a free pet travel gear item from a shop of the app 100, a discount on future travel bookings, an exclusive access to premium content and features of the app 100, an early access to new travel packages available through the app 100.

The processor module 510 of the AI system 500 can further include one or more software modules, including an information collection module and a document generation module. The information collection module can be connected functionally and communicatively to the chatbot 520. The information collection module can include program instructions for automatically generating interview questions, providing the questions to the chatbot 520, and receiving user information from the chatbot 520. The information module can use natural language processing techniques to distill user information from user interaction with the chatbot 520. For example, the chatbot 520 can monitor a user response for keywords predefined by the AI system 500. The information module can access a library of reference information to obtain information about the user, the pet, the destination of the trip, the mode of transportation, the accommodations, the medical concerns, the legal concerns. In some arrangements, the chatbot 520 or the information module can use a retrieval-augmented generation (RAG) system.

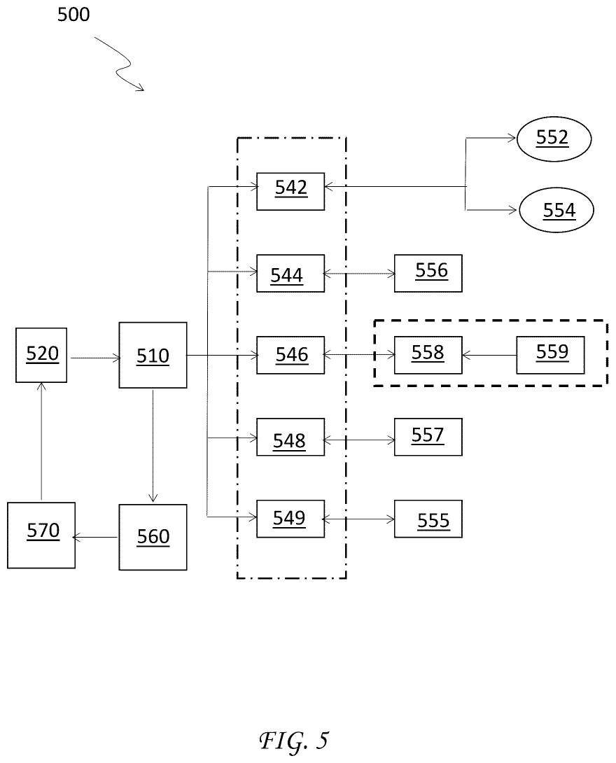

FIG. 5 shows a non-limiting, illustrative example of an AI system 500 for an AI pet travel assistant app 100, according to some aspects of the present disclosure. In some aspects, the AI system 500 can power a pet travel and recommendation engine, as described herein. The user can interact with the system 500 through the app 100, which can act as the front-end client. For example, when a user requests a travel plan (e.g., through a chatbot 520), the app 100 can send the request to the pet travel AI (e.g., the processor module 510). The processor module 510 can run a set of agentic workflows (indicated by the dash-dot box in FIG. 5) to gather and consolidate all necessary information for assisting the user with the pet travel plan. FIG. 5 indicates that, in some arrangements, the agentic workflows can include: a database agent 542, a travel inventory agent 544, a regulations agent 546, a medical agent 548, an insurance agent 549. The database agent 542 can pull data about the pet from a pet database 552 and can pull data about the user from a user database 554, as indicated in FIG. 5. The travel inventory agent 544 can query via a global distribution service 556 information about flights, hotels, cars, cruises, and other accommodations for the user's trip. The regulations agent 546 can use a retrieval-augmented generation pipeline (indicated by the dashed box in FIG. 5) to pull updated travel rules and pet policies from a regulations vector database 558, which may include a regulation document 559 embedded in the regulations vector database 558. The medical agent 548 can check for relevant veterinary appointments and medical requirements, for example, by querying a veterinary inventory 557 via a medical provider application programming interface. The insurance agent 549 can look up required or elective insurance options for the journey, for example, by querying an insurance inventory 555 via an insurance provider application programming interface.

FIG. 5 further shows that once the AI system 500 has collected the required data, the processor module 510 can use a data-processing module 560 to consolidate the data and to process the data to clean up the data and normalize the data into a standardized schema or model. This processed data can then be used by a generation module 570 to generate for the user a recommendation (e.g., a travel recommendation, a medical recommendation, an insurance recommendation, a legal recommendation) or a travel document (e.g., a personalized checklist, a personalized itinerary). In some aspects, the AI system 500 can perform functions such as retrieving user and pet metadata from a persistent user database. As described herein, the system 500 can invoke multiple asynchronous agents to retrieve travel, regulatory, medical, and insurance data. In some aspects, the system 500 can receive and standardize data responses into a unified object model. The AI system 500 disclosed herein can resolve data conflicts based on context relevance to the specific pet profile (e.g., breed, age, medical history). In some aspects, the AI system 500 can generate a sequenced itinerary and a checklist of required travel actions.

### Other Variations and Terminology

While certain embodiments have been described, these embodiments have been presented by way of example only and are not intended to limit the scope of protection. Indeed, the novel methods and systems described herein may be embodied in a variety of other forms. It will be further understood by those skilled in the art that the present disclosure extends beyond the specifically disclosed embodiments to other alternative embodiments or uses and obvious modifications and equivalents thereof, including embodiments which do not provide all of the features and advantages set forth herein. Furthermore, various omissions, substitutions, and changes in the form of the methods and systems described herein may be made. Those skilled in the art will appreciate that in some embodiments, the actual steps taken in the processes illustrated or disclosed may differ from those shown in the figures. Depending on the embodiment, certain of the steps described above may be removed; others may be added. Accordingly, the scope of the present disclosure is not intended to be limited by the specific disclosures of preferred embodiments herein and may be defined by claims as presented herein or as presented in the future. The language of the claims is to be interpreted broadly based on the language employed in the claims and not limited to the examples described in the patent specification of during prosecution of the application, which examples are to be construed as non-exclusive.

Features, materials, characteristics, or groups described in conjunction with a particular aspect, embodiment, or example are to be understood to be applicable to any other aspect, embodiment, or example described herein unless incompatible therewith. All of the features disclosed in this specification (including any accompanying claims, abstract, and drawings), or all of the steps of any method or process so disclosed, may be combined in any combination, except combinations where at least some of such features or steps are mutually exclusive. The protection extends to any novel one, or any novel combination, of the features disclosed in this specification (including any accompanying claims, abstract, and drawings), or to any novel one, or any novel combination, of the steps of any method or process so disclosed.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

What is claimed is:

1. An artificial intelligence (AI) powered pet travel assistant app comprising:
a processor; and
one or more computer-readable data storage devices storing program instructions that when executed by the processor, control the AI powered pet travel assistant app to perform operations comprising:
determining, by conversing with a user via a chatbot, a pet-travel data selected from the group consisting of: a travel destination, a travel mode, a pet characteristic, a user characteristic, a pet accommodation, a legal requirement, and a medical characteristic;
generating a travel document based on the pet-travel data, the travel document selected from the group consisting of: an itinerary, a checklist, a booking option, a booking confirmation, a medical document, and a legal document; and
displaying the travel document to the user.

2. The app of claim 1, wherein the app is further configured to perform an operation of accessing through a data channel an information source.

3. The app of claim 2, wherein the information source is selected from the group consisting of: an accommodations information source, a transport information source, a medical information source, a regulations information source, and an insurance information source.

4. The app of claim 2, wherein the information source comprises a global distribution system.

5. The app of claim 2, wherein the information source comprises a user-history database comprising a user-preference data based on an earlier interaction of the user with the app.

6. The app of claim 2, wherein accessing an information source comprises scanning the information source using an agentic workflow.

7. The app of claim 2, wherein accessing the information source comprises using a retrieval-augmented generation pipeline to obtain information from the information source.

8. A method of generating a pet-travel document using an artificial intelligence (AI) powered pet travel assistant app, the method comprising:
conversing with a user via a chatbot to identify a pet-travel characteristic of a trip for which the user is planning to bring a pet;
accessing an information source to obtain a trip-relevant data for the trip based on the pet-travel characteristic;
generating a travel document based on the trip-relevant data; and
displaying the travel document to the user.

9. The method of claim 8, wherein the travel document is a dynamic itinerary, and the app is further configured to update a content of the dynamic itinerary to reflect an information update obtained by the app from the information source.

10. The method of claim 8, wherein the travel document is a checklist comprising a list of items for the user to bring on the trip.

11. The method of claim 8, wherein accessing the information source comprises using a web crawler to scan the information source.

12. The method of claim 8, wherein accessing the information source comprises using a set of agentic workflows to access a plurality of information sources.

13. The method of claim 8, wherein the information source is a regulations database and accessing the information source comprises using a retrieval-augmented generation pipeline to obtain an updated travel rule from the regulations vector database.

14. The method of claim 8, wherein conversing comprises the chatbot presenting to the user an initial query and a subsequent query, the initial query eliciting an initial response from the user, the chatbot basing the subsequent query on a content of the initial response.

15. An artificial intelligence (AI) system of an AI-powered pet travel assistant app, the system comprising:
a chatbot configured to present to a user a trip query, the chatbot further configured to receive from the user a user response to the trip query;
a processor module configured to instruct the chatbot of the trip query to present to the user, the processor module further configured to access an information source and to obtain travel information from the information source; and
a generation module that generates for the user, based on the travel information and the user response, a recommendation or a travel document.

16. The system of claim 15, wherein the information source comprises a plurality of databases and the processor module uses a set of agentic workflows to query the plurality of databases.

17. The system of claim 15, wherein the information source comprises a regulations database and the processor module uses a retrieval-augmented generation pipeline to obtain updated information from the regulations database.

18. The system of claim 15, wherein the information source comprises a user preference data based on an earlier interaction of the user with the app.

19. The system of claim 18, wherein the generation module populates at least a portion of the travel document based on the user preference data.

20. The system of claim 18, wherein the processor module uses the user preference data to select the trip query to present to the user via the chatbot.
